(19) United States
(12) Patent Application Publication
(10) Pub. No.: US 2012/0104151 A1
(43) Pub. Date: May 3, 2012

(54) POWERED PARAFOIL CARGO DELIVERY DEVICE AND METHOD

(75) Inventor: Sean Mccann, Burritt's Rapids (CA)

(73) Assignees: Mist Mobililty Integrated Systems Technology (MMIST) Inc., Ottawa (CA); Elbit Systems Ltd., Haifa (IL)

(21) Appl. No.: 13/381,100

(22) PCT Filed: Jun. 14, 2010
(86) PCT No.: PCT/IL10/00468

§ 371 Date: Dec. 28, 2011

Related U.S. Application Data
(60) Provisional application No. 61/223,130, filed on Jul. 6, 2009.

(51) Int. Cl. B64D 1/12; B64C 31/036; B64D 1/22

(52) U.S. Cl. 244/13; 244/137.1; 244/137.4

(57) ABSTRACT

A powered parafoil device is disclosed. The device includes a main body provided with at least one thrust generator for imparting the main body thrust in a determined direction. The device is also includes a parafoil connected to the main body by cords attached to the main body at attachment positions, and a tilting mechanism for tilting the main body with respect to the parafoil, when airborne. The tilting mechanism is capable of tilting the main body between at least two states: in the first state the determined direction of the thrust is substantially parallel to the direction of flight of the device when airborne, and in the second state the determined direction of the thrust is tilted with respect to the direction of flight of the device when airborne, imparting the main body a thrust vector component in the vertical direction. A method for increasing lift of a powered parafoil device and methods for cargo delivery are also disclosed.

### FIELD OF THE INVENTION

The present invention relates to airlift. More particularly, the present invention relates to a powered parafoil cargo delivery device and method.

### BACKGROUND OF THE INVENTION

Airlift, and in particular airdrop, is an efficient method of transporting a cargo, such as, for example, supplies, to a drop zone. Sometimes airdrop is the only possible method of transportation (in harsh terrain, secluded or isolated places, danger or war zones, and other such inaccessible zones).

Airdrop is carried out by an aircraft. The cargo is usually loaded on the aircraft or suspended from the aircraft. The aircraft, which may be, for example, a transport airplane, a helicopter, a glider or a parafoil, then flies to the target drop zone and releases the payload over that zone, allowing the payload to parachute or freely fall downwards.

Powered parafoils may be used for airdrop tasks. A powered parafoil is a steerable aircraft that has a non-rigid textile wing in the shape of an elongated parachute having a cell structure, which is inflated by air to present a wing cross section. The aircraft is powered by a motorized vertical rotor that provides a forward thrust and may be steered in the desired direction by manipulating the parachute cords.

Due to its nature, the overall weight of powered parafoil determines its airspeed.

This also limits the weight with which a powered parafoil may take off, as the aircraft has to accelerate across a take-off land strip to gain enough speed for take-off, and additional weight requires more energy to overcome the additional weight as well as the ground friction.

It is a purpose of the present invention to provide a powered parafoil cargo delivery device and method, facilitating fast pick-up of the cargo and safe and accurate delivery to the designated drop zone.

Other aims and advantages of the present invention will become apparent after reading the present invention and reviewing the accompanying drawings.

### SUMMARY OF THE INVENTION

A powered parafoil cargo delivery device and method, facilitating fast pick-up of the cargo and safe and accurate delivery to the designated drop zone is disclosed in the present specification.

According to embodiments of the present invention, there is provided a powered parafoil device. The device includes a main body provided with at least one thrust generator for imparting the main body thrust in a determined direction, a parafoil connected to the main body by cords attached to the main body at attachment positions, and a tilting mechanism for tilting the main body with respect to the parafoil, when airborne between at least two states. In the first state the determined direction of the thrust is substantially parallel to the direction of flight of the device when airborne, and in a second state the determined direction of the thrust is tilted with respect to the direction of flight of the device when airborne, imparting the main body a thrust vector component in the vertical direction.

Furthermore, according to embodiments of the present invention, said at least one thrust generator is selected from the group of thrust generators that includes engine powered rotor, rocket and jet engine.

Furthermore, according to embodiments of the present invention, said at least one thrust generator includes an engine powered back rotor and an engine powered front rotor.

Furthermore, according to embodiments of the present invention, the tilting mechanism comprises a repositioning mechanism for repositioning the location of the attachment positions with respect to the main body.

Furthermore, according to embodiments of the present invention, the device includes a cargo attachment for snagging a designated cargo while flying over it, suspending the cargo while flying and releasing the cargo at a designated drop zone.

Furthermore, according to embodiments of the present invention, the cargo attachment includes a sling and a controllable hook for engaging and disengaging with a cargo.

Furthermore, according to embodiments of the present invention, the sling has an adjustable length.

Furthermore, according to embodiments of the present invention, there is provided a method for increasing lift of a powered parafoil device The device includes a main body provided with at least one thrust generator for imparting the main body thrust in a determined direction; a parafoil connected to the main body by cords attached to the main body at attachment positions, where the main body is generally in a first state wherein the determined direction of the thrust is substantially parallel to the direction of flight of the device when airborne. The method includes providing a tilting mechanism for tilting the main body with respect to the parafoil, when airborne; and tilting the main body to a second state wherein the determined direction of the thrust is tilted with respect to the direction of flight of the device when airborne, imparting the main body a thrust vector component in the vertical direction.

Furthermore, according to embodiments of the present invention, there is provided a method for cargo delivery. The method includes providing a powered parafoil cargo delivery device that includes a main body provided with at least one thrust generator for imparting the main body thrust in a determined direction; a parafoil connected to the main body by cords attached to the main body at attachment positions; a tilting mechanism for tilting the main body with respect to the parafoil, when airborne; and a cargo attachment for snagging a designated cargo while flying over it, suspending the cargo while flying and releasing the cargo at a designated drop zone. The method also includes flying the device to a cargo pick-up point, tilting the main body using the tilting mechanism so that the direction of the thrust is tilted with respect to the direction of flight of the device, imparting the main body a thrust vector component in the vertical direction, and snagging the cargo using the cargo attachment while flying over it; flying the device with the cargo to a drop zone; and dropping the cargo at the drop zone by releasing the cargo from the cargo attachment.

Furthermore, according to embodiments of the present invention, the method includes tilting the main body using the tilting mechanism after the snagging of the cargo so as to realign the direction of thrust and the direction of flight of the device when airborne.

Furthermore, according to embodiments of the present invention, the method includes maintaining the cargo at the pick up point at an elevated position with respect to ground level to allow room for elevation loss of the device after snagging of the cargo.

12. The method according to claim 9, comprising maintaining the cargo stationary when snagged.

13. The method according to claim 9, comprising moving the cargo when snagged substantially parallel to the device.

14. The method according to claim 9, wherein the step of flying the device to a cargo pick-up point includes navigating the device to the pick-up point.

15. The method according to claim 9, wherein the step of flying the device to a cargo pick-up point includes homing the device to the cargo pick-up point using a homing technique.

16. A method for cargo delivery comprising:
providing a powered parafoil cargo delivery device that includes a main body provided with at least one thrust generator for imparting the main body thrust in a determined direction; a parafoil connected to the main body by cords attached to the main body at attachment positions; a tilting mechanism for tilting the main body with respect to the parafoil, when airborne;
flying the device with attached cargo to a drop zone;
tilting the main body using the tilting mechanism so that the direction of the thrust is tilted with respect to the direction of flight of the device, imparting the main body a vectored thrust so as to allow reducing airspeed; and
dropping the cargo at the drop zone by releasing the attached cargo from the device.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1A illustrates a powered parafoil cargo delivery device according to an embodiment of the present invention, in a straight and leveled flight.

FIG. 1B illustrates a powered parafoil cargo delivery device according to an embodiment of the present invention, in a straight flight, with the main body titled as a result of changing the attachment position of the parafoil cords.

FIG. 2 illustrates a possible mechanism for repositioning the attachment position of the parafoil cords to the body of the powered parafoil cargo delivery device shown in FIG. 1.

FIG. 3 is a control scheme of a powered parafoil cargo delivery device according to an embodiment of the present invention.

FIG. 4 shows stages of an airlift method (launch and climb) using a powered parafoil cargo delivery device according to an embodiment of the present invention.

FIG. 5 shows advanced stages of an airlift method (snag and accelerate) using a powered parafoil delivery device, according to an embodiment of the present invention.

FIG. 6 shows final stages of an airlift method (drop, return and land) using a powered parafoil delivery device, according to an embodiment of the present invention.

FIG. 7 illustrates a controllable cargo bay which may be incorporated with a powered parafoil delivery device, according to embodiments of the present invention.

### DETAILED DESCRIPTION OF EMBODIMENTS

In the following detailed description, numerous specific details are set forth in order to provide a thorough understanding of the invention. However, it will be understood by those of ordinary skill in the art that the invention may be practiced without these specific details. In other instances, well-known methods, procedures, components, modules, units and/or circuits have not been described in detail so as not to obscure the invention.

Embodiments of the invention may include an article such as a computer or processor readable medium, or a computer or processor storage medium, such as for example a memory, a disk drive, or a USB flash memory, encoding, including or storing instructions, e.g., computer-executable instructions, which when executed by a processor or controller, carry out methods disclosed herein.

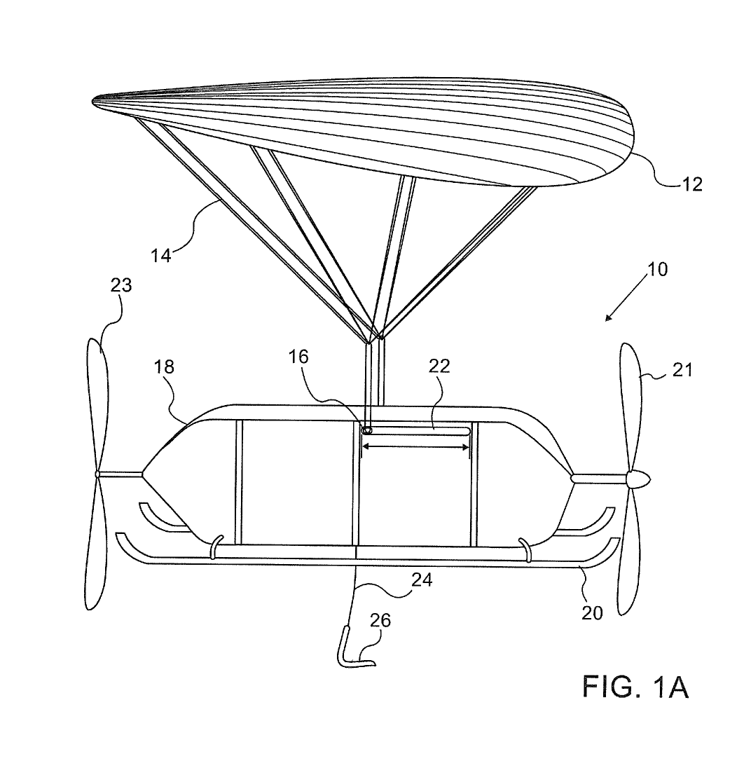

Reference is made to FIG. 1A, illustrating a powered parafoil cargo delivery device 10, according to an embodiment of the present invention, in a straight and leveled flight. A powered parafoil cargo delivery device 10, according to an embodiment of the present invention, includes a parafoil 12, which is connected to a main body 18 (with skids 20) by means of cords 14, and is deployed over main body 18, when wind fills the parafoil, carrying the body. The main body may be provided with wheels instead of skids, or other ground support, and may also lack any such ground support.

Main body 18 is provided with engine powered front rotor 21 and engine powered back rotor 23. In alternative embodiments the main body is provided with only one engine powered rotor, either in front or at the rear end of the main body.

The cords 14 are connected to main body at two opposite attachment positions 16 (only one is shown, the other is hidden on the opposite side of main body 18), so as to allow the main body to be suspended from the parafoil in a substantially horizontal position, during normal flight.

The aircraft is provided with a cargo attachment for snagging a designated cargo while flying over it, suspending the cargo while flying and releasing the cargo at a designated drop zone, such as, for example, a sling 24 having an adjustable length, so that it may be lowered from main body 18 (for example by a winch) and a controllable hook 26, designed to engage and disengage with designated cargo.

When main body 18 is horizontally leveled back rotor 23, or front rotor 21, or both rotors provide the aircraft with the thrust needed to advance. The airspeed needed to maintain the aircraft flying leveled and straight depends on the weight of the aircraft. In order to allow the aircraft to slow down yet maintain substantially constant elevation, attachment positions 16 can be relocated along a substantially dual track 22, so as to change the attachment position of the cords 14 with respect to main body 18 (see FIG. 1B, illustrating a powered parafoil cargo delivery device 10, according to an embodiment of the present invention, in a straight flight in a tilted configuration). Changing of the location of the attachment position of the parafoil cords causes main body to tilt backwards, its front raised and its rear lowered. Front rotor 21 is then employed, while main body 18 is tilted at an angle with respect to the horizon, generating a vector thrust 15 with a horizontal component 17 and a vertical component 19. While the horizontal component 17 of the thrust causes the aircraft to move forward (at a slower speed, as only a portion of the thrust contributes to forward motion), the vertical component 19 causes the parafoil to experience reduced weight hence facilitating maintaining the aircraft at the same elevation at a reduced speed.

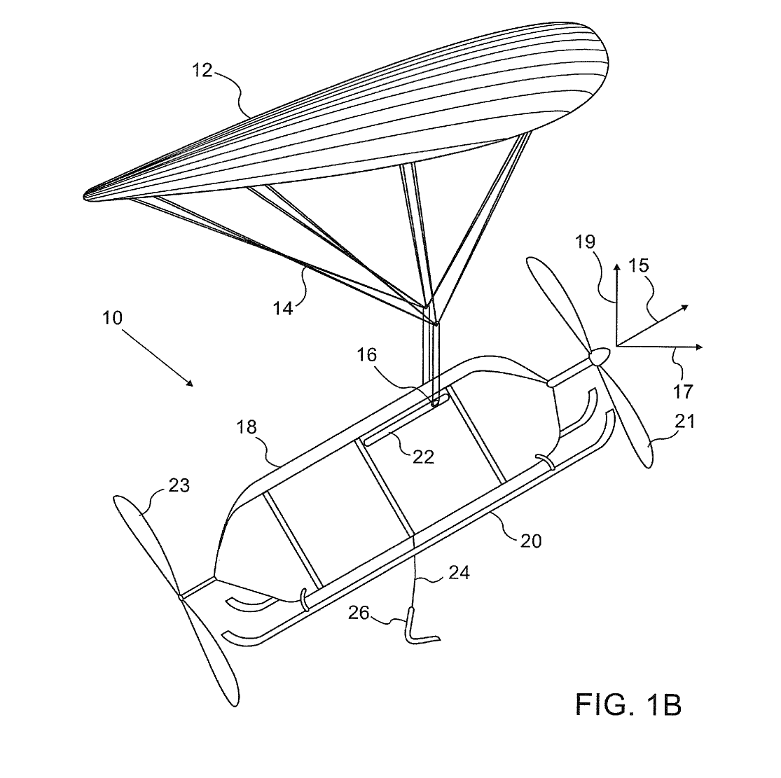

The repositioning of the cord attachment positions 18 can be accomplished, for example, by employing the mechanism 35 for repositioning the attachment position of the parafoil cords to the body of the powered parafoil cargo delivery device depicted in FIG. 2. Elongated screw 33, threaded through bore 31 in bar 16, which is provided with internal threading, is rotated by motor 30, governed by control 32. When turned in one direction bar 16 moves in one direction along dual track 22. When the direction of rotation of screw 33 is reversed, bar 16 moves in the opposite direction along dual track 22.

The tilting of the main body with respect to its direction of flight may be achieved in other ways too. In one example, the main body may be provided with a repositioning mechanism for the sling. The sling then may be repositioned beneath the main body so that the weight of the cargo is moved with respect to the center of gravity of the main body, causing the main body to tilt.

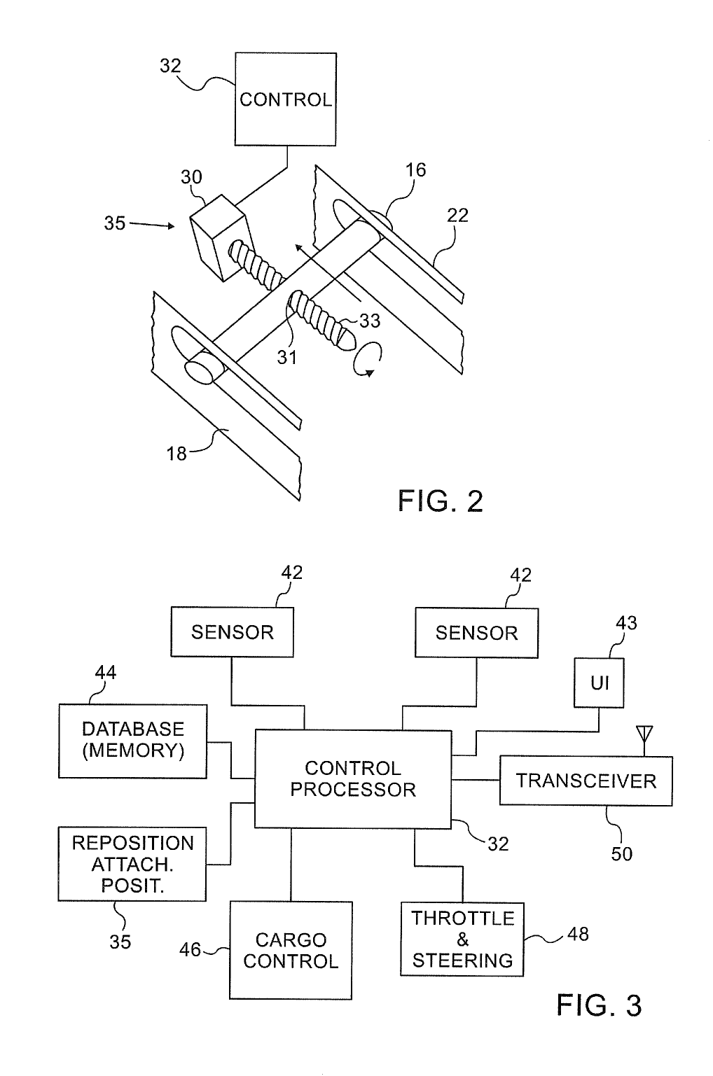

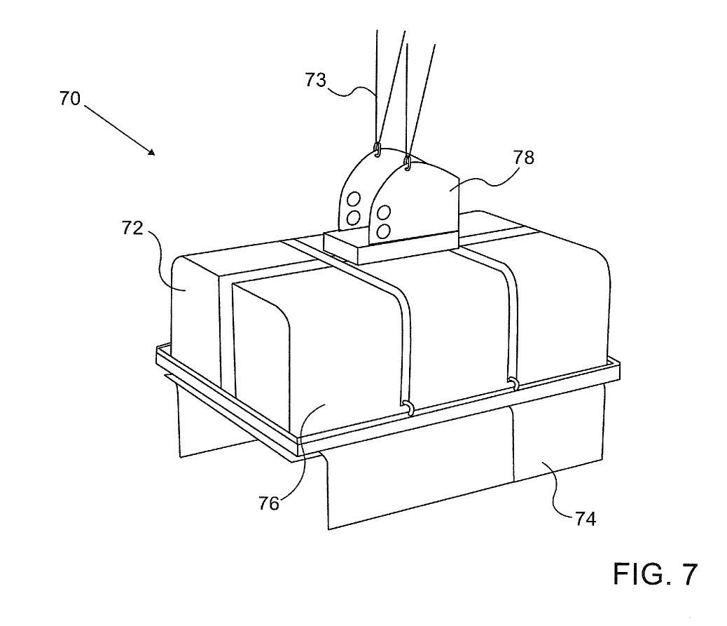

FIG. 3 illustrates a control scheme for a powered parafoil cargo delivery device 10, according to an embodiment of the present invention. One or more sensors, for sensing, for example, elevation, location, speed, inertia, or other parameters, is communicating with control processor 32. Database 44 (memory) may store an executable program for execution by processor 32, as well as relevant data. Control processor 32 actuates and controls the reposition mechanism for repositioning the attachment positions 35, and also governs the operation of throttle (rotors 21 and 23, see FIGS. 1A and 1B) and steering 48 of the powered parafoil. Control processor 32 may also be used to control the cargo itself 46 (see also FIG. 7 and the corresponding explanation in the present specification).

Other possible mechanisms for changing the location of the attachment positions of the parafoil cords may include, for example, worm gear, pneumatic mechanism, electric mechanisms and various other known mechanisms.

The ability to fly a parafoil at a reduced forward speed, while maintaining the same elevation, and acquiring a vertical thrust component (hereiafter referred to as—vectored thrust) as described hereinabove can be utilized in a novel method for airlift involving cargo pick up by a flying powered parafoil delivery device and dropping the cargo at a designated drop zone, according to an embodiment of the present invention.

It is asserted that a powered parafoil cargo delivery device, in accordance with embodiments of the present invention may utilize the ability to fly at a predetermined elevation with reduced speed to airlift a heavy cargo, which would have been impossible or very difficult for the powered parafoil to take off with. Instead of taking off with the cargo attached to it, the powered parafoil delivery device, according to embodiments of the present invention, takes off without the cargo, flies to a location of the cargo, lowers the sling with the hook and snags the cargo while passing over it.

As this requires accuracy and precision, the aircraft is first made to reduce its airspeed in the manner described hereinabove.

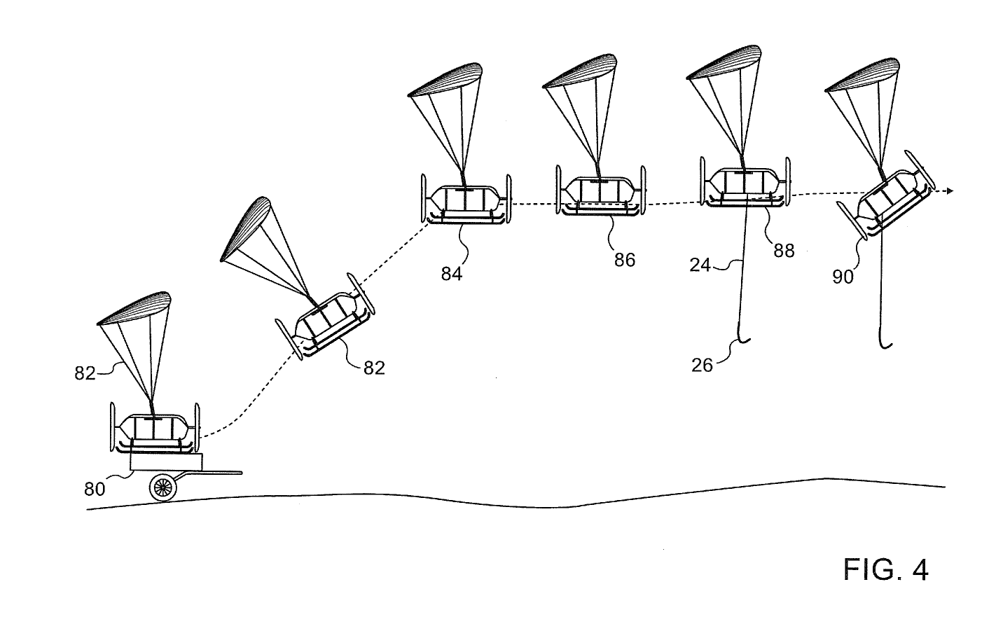

FIG. 4 shows stages of an airlift method (launch and climb) using a powered parafoil cargo delivery device according to an embodiment of the present invention.

A powered parafoil cargo delivery device 82, according to embodiments of the present invention, is launched separately from its cargo. The launch may be vehicle assisted by (for example, a trailer or a truck). The vehicle carries the aircraft and accelerates until the parafoil deploys and gains lift at which point the aircraft takes off. The aircraft uses its rear rotor to climb until it reaches a cruise altitude 84. Then the front rotor is started 86, the hook is lowered 88, and the aircraft reduces its airspeed by changing the position of the main body beneath the parafoil in the manner described hereinabove using the rotors to produce vectored thrust 90.

For a typical powered parafoil aircraft may carry some 1400 lbs (total weight), with a parafoil area of some 680 sq. feet (2.2 lbs/sq. feet), the takeoff speed is about 25 knots (as indicated by the Air Speed Indicator—ASI). It then climbs using its rear rotor to reach a cruise altitude, flying straight and leveled at 30 knots, and some 15 knots when the main body is tilted (vectored thrust).

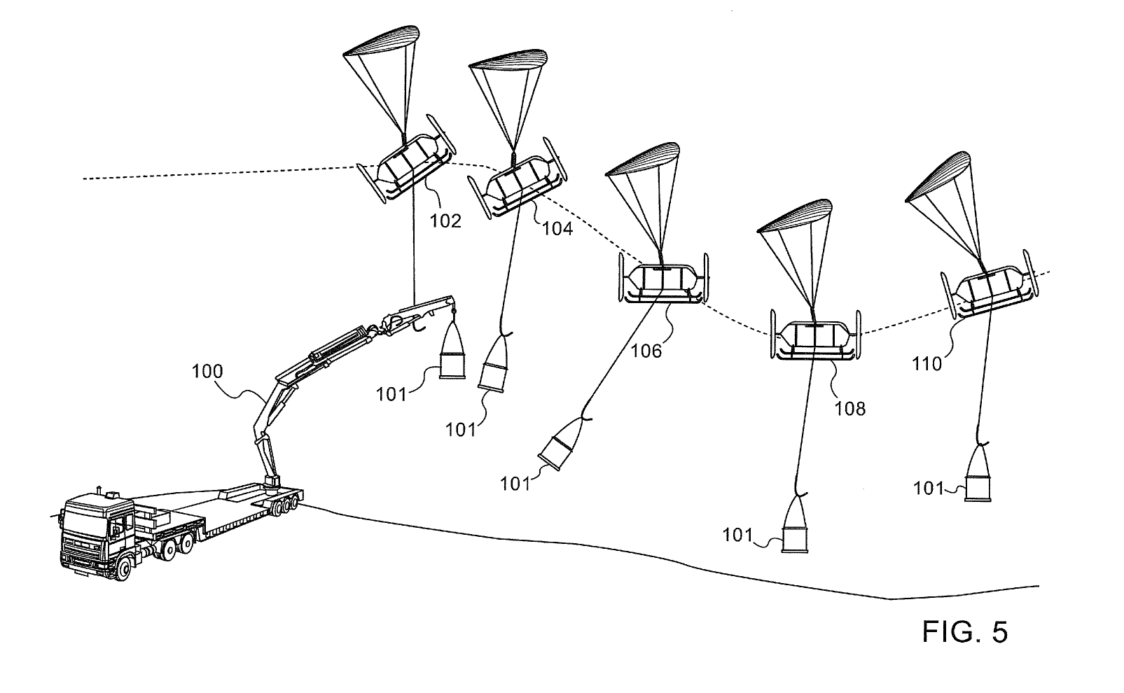

FIG. 5 shows advanced stages of an airlift method (snag and accelerate) using a powered parafoil delivery device, according to an embodiment of the present invention.

The powered parafoil delivery device flies over 102 the cargo 101 at a reduced airspeed with its hook lowered, the cargo preferably raised by a crane 100 or other lifting means, poised for snagging. The aircraft snags the cargo 104 with its hook, and returns to a horizontal, leveled position, while the cargo is lifted 106, initially reducing its altitude 108 but climbing again 110. The vectored thrust offers a vertical component of the thrust that acts against the weight of the cargo to balance the flying aircraft. The aircraft may accelerate just before snagging the cargo.

The cargo is positioned at an elevated place so as to allow the aircraft room for reducing its altitude due to the abrupt addition of weight.

The cargo may be stationary when snagged by the aircraft, or it may be moving. It may be advantageous to move the cargo along a path (e.g. a track) which is aligned parallel to the aircraft flight path (at a slower or same speed as the aircraft) so as to reduce the abrupt pull which is experienced by the aircraft when the cargo is swung in the air.

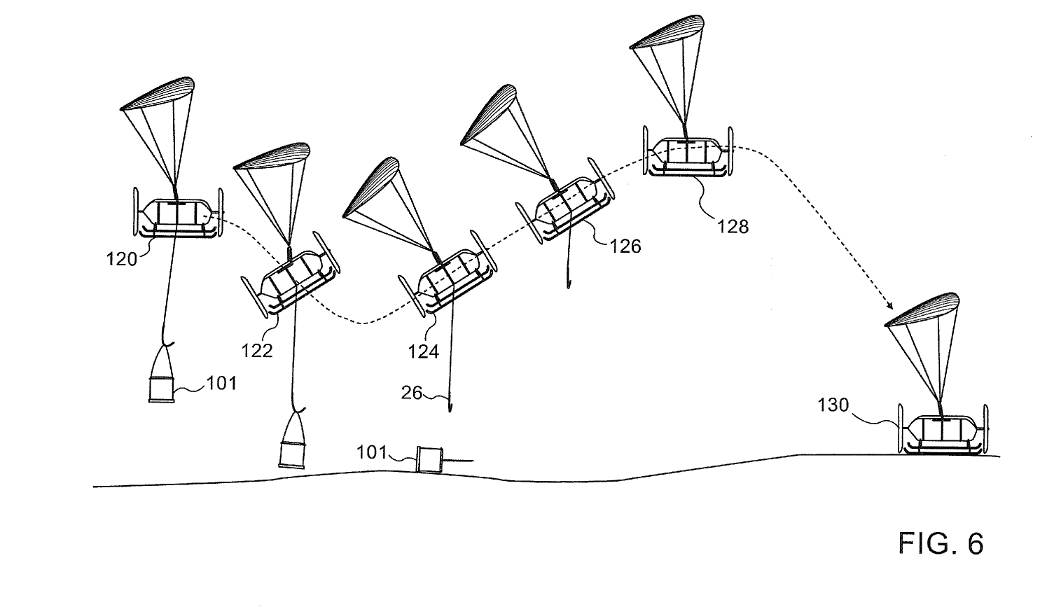

FIG. 6 shows final stages of an airlift method (drop, return and land) using a powered parafoil delivery device, according to an embodiment of the present invention.

The aircraft flies to the designated drop zone 120, where it reduces its airspeed using vectored thrust 122. It then drops the cargo 124 by releasing cargo 101 from hook 26. The main body is realigned with the direction of flight and the aircraft starts climbing 126 until it reaches a cruise altitude 128. Later the aircraft lands 130 at a designated landing zone.

FIG. 3 is a control scheme of a powered parafoil cargo delivery device according to an embodiment of the present invention. A powered parafoil cargo delivery device, according to embodiments of the present invention may include one or more sensors 42 for sensing various flight or aircraft parameters, such as for example, strain sensor for sensing strain of the parafoil cables (indicative of the weight of the aircraft, with and without the cargo), global positioning system (GPS) receiver, inertial measurement unit (IMU), Gyro, accelerometers, compass, and speed indicator, altitude sensor. Control processor 32 receives sensed data from the sensors and processes this data. The control processor 32 may be programmed to execute a program stored in memory 44. The control processor may control the throttle and steering 48 (flight controls) of the aircraft. Control processor 32 may also govern and operate cargo control 46. During flight, control processor 32 may actuate repositioning of the attachment positions of the parafoil cords so as to tilt the main body backwards or regain its horizontal position.

The control processor may include an executable program that causes the powered parafoil delivery device, according to embodiments of the present invention, to perform an entire airlift task. This includes instructions to take off, fly to a pick-up point, maneuver the aircraft to perform vectored thrust, operate the sling and hook to snag a cargo, fly with the cargo to a drop zone, drop the cargo at the drop zone and fly to a landing site.

If the weight of the cargo to be picked up is a-priori given performance parameters for the vector thrust maneuver may be predetermined. A user interface 43 may be provided to allow an operator to input task data, such as, for example, navigation points, flight course, cargo pick-up location, drop zone location and landing location. Task data may also be remotely communicated to the control processor via transducer 50.

A powered parafoil delivery device, according to embodiments of the present invention, may include a transceiver 50 for receiving data communication such as, for example, navigation data, action commands and manual override control.

FIG. 7 illustrates a controllable cargo bay 70 which may be incorporated with a powered parafoil delivery device, according to embodiments of the present invention. Cargo bay 70 includes a casing 76 that includes one or more compartments 72 (six compartments appear in the example shown in FIG. 7). each compartment has a bottom door 74 which is separately controlled. Controller 78, which communicates with control processor 32 (see FIG. 3) of a powered parafoil delivery device, according to embodiments of the present invention, when hooked and suspended beneath the main body of the powered parafoil delivery device, receives commands and operates the bottom doors. The compartments may be used to carry similar or different items to be dropped at different drop zones, so that when the aircraft reaches a drop zone the bottom door of a compartment in which cargo to be dropped at that drop zone is located is opened, allowing that cargo to drop (free falling, parachuting, gliding or flying off that compartment). When dropping cargo at different drop zones is desired, weight changes should be taken into consideration. The rotor thrust will be adjusted to allow the aircraft to maintain a desired altitude.

The powered parafoil delivery device, according to embodiments of the present invention, may be remotely controlled, it may be manned, with or without manual steering and control, or it may be unmanned.

The powered parafoil delivery device, according to embodiments of the present invention, may be directed to the pick-up point by navigation. Alternatively, the cargo pick-up point may be provided with a homing beam or other homing device towards which the powered parafoil delivery device will travel using appropriate homing equipment.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A method of lifting cargo from a surface, comprising:
flying a powered parafoil cargo delivery device over the cargo;
snagging the cargo while flying over it; and
lifting the cargo off the surface to an elevated level above said surface while maintaining said flight.

2. A powered parafoil device comprising:
a main body provided with at least one thrust generator for imparting the main body thrust in a determined direction;
a parafoil connected to the main body by cords attached to the main body at attachment positions; and
a tilting mechanism which comprises a repositioning mechanism for repositioning the location of said attachment positions with respect to said main body, for tilting the main body with respect to the parafoil, when airborne between at least two states,
wherein in a first state the determined direction of the thrust is substantially parallel to the direction of flight of the device when airborne, and
wherein in a second state the flight is maintained in a generally constant elevation, but the determined direction of the thrust is tilted with respect to the direction of flight of the device when airborne, imparting the main body a thrust vector having a component in the vertical direction and a component in said direction of flight.

3. The device according to claim 2, wherein said at least one thrust generator is selected from the group of thrust generators that includes engine powered rotor, rocket and jet engine.

4. The device according to claim 2, wherein said at least one thrust generator includes an engine powered back rotor and an engine powered front rotor.

5. The device according to claim 2, comprising a cargo attachment for snagging a designated cargo while flying over it, suspending the cargo while flying and releasing the cargo at a designated drop zone.

6. The device according to claim 5, wherein the cargo attachment includes a sling and a controllable hook for engaging and disengaging with a cargo.

7. The device according to claim 6, wherein the sling has an adjustable length.

8. A method for increasing lift of a powered parafoil device, the device including a main body provided with at least one thrust generator for imparting the main body thrust in a determined direction; a parafoil connected to the main body by cords attached to the main body at attachment positions, where the main body is generally in a first state wherein the determined direction of the thrust is substantially parallel to the direction of flight of the device when airborne, the method comprising:
operating a tilting mechanism for tilting the main body with respect to the parafoil, when airborne, such as to tilt the main body to a second state wherein the flight is maintained in a generally constant elevation, but the determined direction of the thrust is tilted with respect to the direction of flight of the device when airborne, imparting the main body a thrust vector having a component in the vertical direction and a component in said direction of flight.

9. A method for cargo delivery comprising:
providing a powered parafoil cargo delivery device that includes a main body provided with at least one thrust generator for imparting the main body thrust in a determined direction; a parafoil connected to the main body by cords attached to the main body at attachment positions; a tilting mechanism for tilting the main body with respect to the parafoil, when airborne; and a cargo attachment for snagging a designated cargo while flying over it, suspending the cargo while flying and releasing the cargo at a designated drop zone;
flying the device to a cargo pick-up point;
tilting the main body using the tilting mechanism so that the direction of the thrust is tilted with respect to the direction of flight of the device, imparting the main body a thrust vector having a component in the vertical direction and a component in said direction of flight such that the flight is maintained in a generally constant elevation, and snagging the cargo using the cargo attachment while flying over it;
flying the device with the cargo to a drop zone; and
dropping the cargo at the drop zone by releasing the cargo from the cargo attachment.

10. The method according to claim 9, comprising tilting the main body using the tilting mechanism after the snagging of the cargo so as to realign the direction of thrust and the direction of flight of the device when airborne.

11. The method according to claim 9, comprising maintaining the cargo at the pick up point at an elevated position with respect to ground level to allow room for elevation loss of the device after snagging of the cargo.

12. The method according of claim 9, comprising maintaining the cargo stationary when snagged.

13. The method according to claim 9, comprising moving the cargo when snagged substantially parallel to the device.

14. The method according to claim 9, wherein the step of flying the device to a cargo pick-up point includes navigating the device to the pick-up point.

15. The method according to claim 9, wherein the step of flying the device to a cargo pick-up point includes homing the device to the cargo pick-up point using a homing technique.

16. A method for cargo delivery comprising:
providing a powered parafoil cargo delivery device that includes a main body provided with at least one thrust generator for imparting the main body thrust in a determined direction; a parafoil connected to the main body by cords attached to the main body at attachment positions; a tilting mechanism for tilting the main body with respect to the parafoil, when airborne;
flying the device with attached cargo to a drop zone;
tilting the main body using the tilting mechanism so that the direction of the thrust is tilted with respect to the direction of flight of the device, imparting the main body a thrust vector having a component in the vertical direction and a component in said direction of flight such that the flight is maintained in a generally constant elevation but at a reduced airspeed; and
dropping the cargo at the drop zone by releasing the attached cargo from the device.
